(19) United States
(12) Patent Application Publication
(10) Pub. No.: US 2018/0375391 A1
(43) Pub. Date: Dec. 27, 2018

(54) MAGNET PLATE FOR LINEAR MOTOR AND LINEAR MOTOR

(71) Applicant: FANUC CORPORATION, Yamanashi (JP)

(72) Inventor: Akira NISHIFUKUMOTO, Yamanashi (JP)

(73) Assignee: FANUC CORPORATION, Yamanashi (JP)

(21) Appl. No.: 15/993,690

(22) Filed: May 31, 2018

(30) Foreign Application Priority Data
Jun. 23, 2017 (JP) 2017-122806

(51) Int. Cl. H02K 1/08; H02K 41/03

(52) U.S. Cl. CPC H02K 1/08; H02K 41/031

(57) ABSTRACT

A magnet plate for a linear motor includes: a plate having a first face and a second face on an opposite side to the first face, and provided with a first fitting part at least partially having a cross-sectional shape indented so as to expand from the second face towards a side of the first face; a permanent magnet disposed on the first face of the plate; and a second fitting part that is fixed to a machine mounting part, and has a cross-sectional shape which can fit together with the first fitting part of the plate.

This application is based on and claims the benefit of priority from Japanese Patent Application No. 2017-122806, filed on Jun. 23, 2017, the content of which is incorporated herein by reference.

### BACKGROUND OF THE INVENTION

### Field of the Invention

The present invention relates to a magnet plate for linear motors and a linear motor equipped therewith.

### Related Art

In recent, years, the use of linear motors as the drive device of a variety of kinds of industrial machines such as the magnetic head drive mechanism of an OA machine, and spindle/table feed mechanism of a machine tool, have been proposed. In this type of linear motor, magnet plates made by arranging a plurality of plate-shaped permanent magnets in planar form have been mostly used as the field magnetic poles. In linear motors of the aforementioned applications, in order to prevent positional shift in an in-plane direction of the permanent magnets arranged in the magnet plate, technology for fixing the permanent magnets by pin-shaped restricting members has been proposed (for example, refer to Patent Document 1).

Patent Document 1: Japanese Unexamined Patent Application, Publication No. 2013-198278

### SUMMARY OF THE INVENTION

In the aforementioned linear motors, if widening the width of the magnet plate (width in direction orthogonal to the movement direction of armature), the flexural rigidity of the magnet plate lowers. In this case, even if positional shift in the plane direction of the permanent magnet is regulated, the magnet plate will deform to the armature side due to the attractive force of the magnetic field generated with the armature, and it becomes difficult to maintain the spacing between the armature and magnet plate at the appropriate interval.

The object of the present invention is to provide a magnet plate for linear motors and a linear motor which can maintain the spacing between the armature and magnet plate at the appropriate interval.

A first aspect of the present invention is related to a magnet plate (for example, the magnet plate 10 described later) for a linear motor that generates driving force for linear motion in cooperation with an armature (for example, the armature 20 described later), the magnet plate including: a plate (for example, the plate 11 described later) having a first face (for example, the first face F1 described later) and a second face (for example, the second face F2 described later) on an opposite side to the first face, and provided with a first fitting part (for example, the groove 110 described later) at least partially having a cross-sectional shape indented so as to expand from the second face towards a side of the first face; a permanent magnet (for example, the permanent magnet 12 described later) disposed on the first face of the plate; and a second fitting part (for example, the guiderail 14 described later) that is fixed to a machine mounting part (for example, the machine mounting part 30 described later), and has a cross-sectional shape which can fit together with the first fitting part of the plate.

According to a second aspect of the present invention, in the magnet plate for a linear motor as described in the first aspect, the first fitting part and the second fitting part may be configured to extent along a movement direction (X direction) of the armature.

According to a third aspect of the present invention, in the magnet plate for a linear motor as described in the second aspect, the first fitting part may be a dovetail groove having a width (W1) wider on a side of the first face than a width (W2) on a side of the second face in a cross section orthogonal to an extending direction (X direction), and the second fitting part may be a guiderail of a dovetail key which is a substantially similar shape to the dovetail groove in a cross section orthogonal to an extending direction.

A fourth aspect of the present invention is related to a linear motor (For example, the linear motor 1 described later) that includes an armature; and the magnet plate for a linear motor as described in any one of the first to third aspects.

According to the present invention, it is possible to provide a magnet plate for linear motors and a linear motor which can maintain the spacing between the armature and magnet plate at the appropriate interval.

### BRIEF DESCRIPTION OF THE DRAWINGS

FIG. 1 is a perspective view showing an outline of a linear motor 1 of a first embodiment;

FIG. 2 is a cross-sectional view of the linear motor 1;

FIG. 3A is a plan view showing an arrangement of plates 11;

FIG. 3B is a plan view showing an arrangement of a guiderail 14;

FIG. 4A is a view showing an assembly procedure of a magnet plate 10;

FIG. 4B is a view showing an assembly procedure of the magnet plate 10;

FIG. 5A is a plan view showing the configuration of a guiderail 14A of a second embodiment;

FIG. 5B is a plan view showing the configuration of a guiderail 14B of a third embodiment;

FIG. 5C is a plan view showing the configuration of a guiderail 14C of a fourth embodiment;

FIG. 6 is a cross-sectional view showing the configurations of a groove 110A and guiderail 14D of a fifth embodiment;

FIG. 7A is a cross-sectional view showing the configurations of a groove 110B and guiderail 14E of a sixth embodiment; and

FIG. 7B is a cross-sectional view showing the configurations of a groove 110C and guiderail 14F of a seventh embodiment.

### DETAILED DESCRIPTION OF THE INVENTION

Hereinafter, an embodiment of the present invention will be explained. It should be noted that the drawings attached to the present disclosure are all schematic diagrams, and the shape of each part, scaling, length/width dimensional ratios, etc. are modified or exaggerated by considering the easy of understanding, etc. In addition, the drawings omit as appropriate the hatching indicative of cross-sections of members, etc.

In the present disclosure, etc., the terms specifying the shape, geometrical conditions, and extents thereof, for example, terms such as “parallel” and “direction”, in addition to the strict meanings of these terms, include the scope of an extent considered to be substantially parallel, and a scope considered to be generally this direction. In the present disclosure, etc., the direction corresponding to the longitudinal direction of a linear motor 1 is defined as X (X1-X2) direction, the direction corresponding to the width (short end) direction is defined as Y (Y1-Y2) direction, and the direction corresponding to the thickness direction is defined as Z (Z1-Z2) direction. In addition, it is similarly defined also for a machine mounting part 30 to which the linear motor 1 is installed.

### First Embodiment

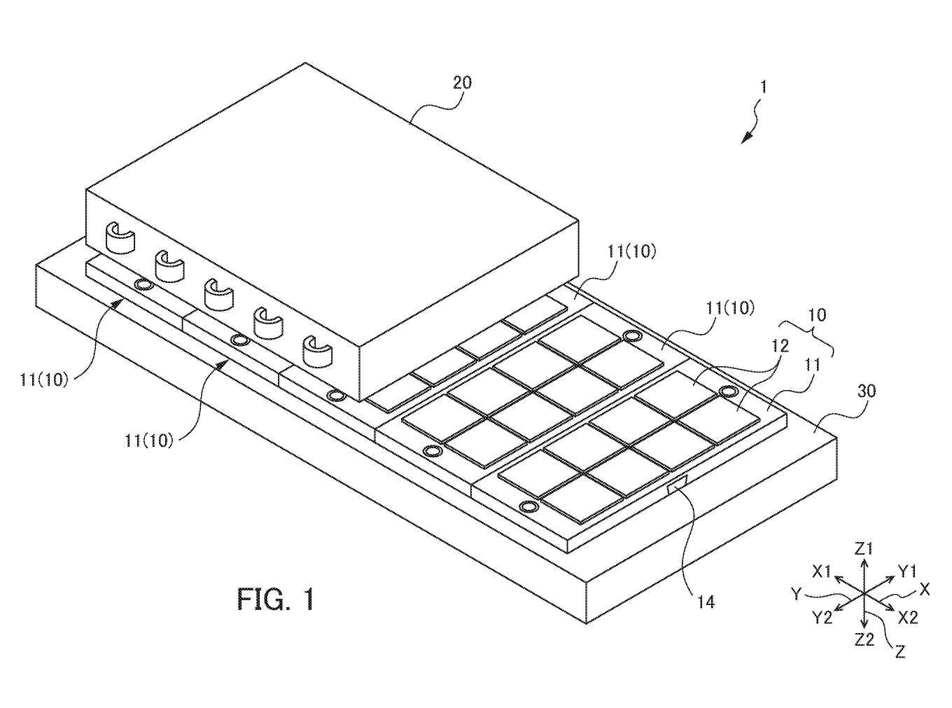

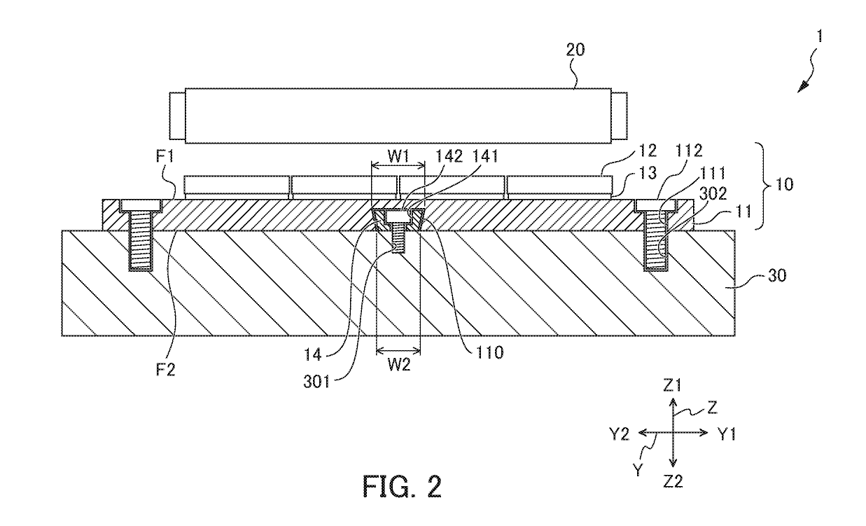

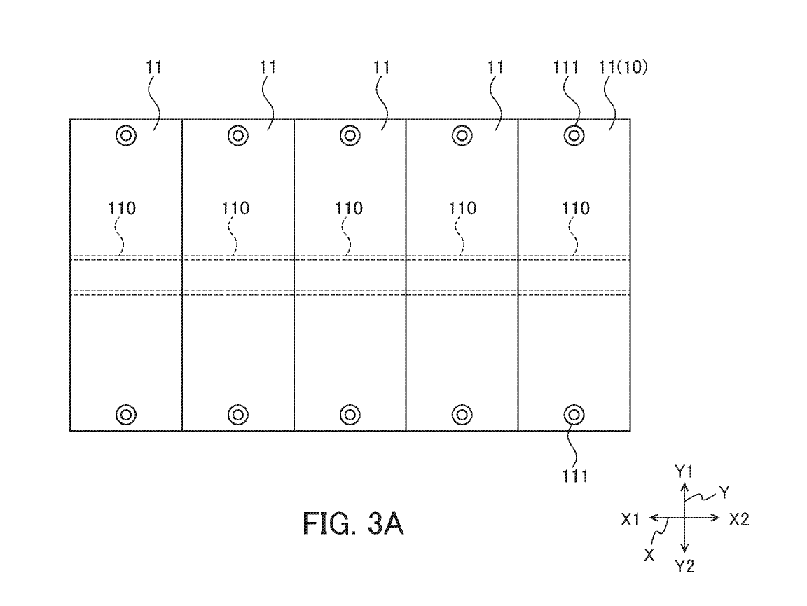

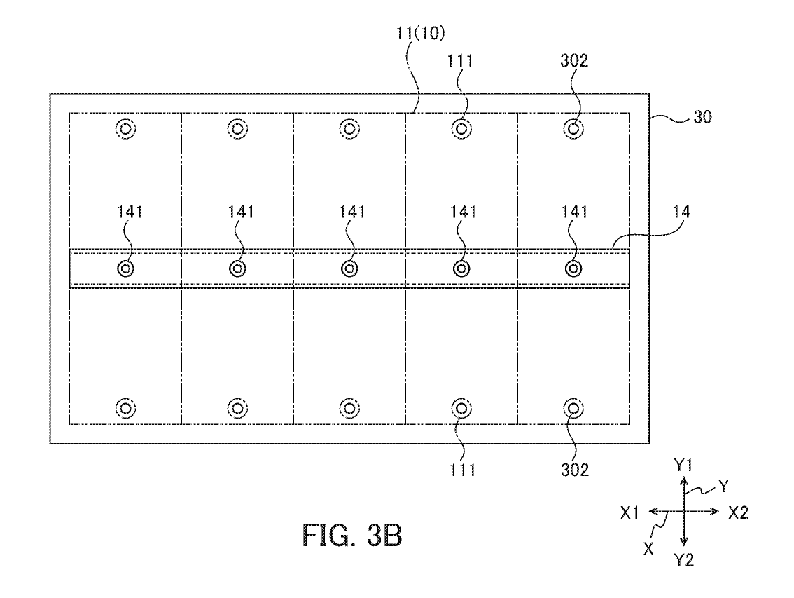

FIG. 1 a perspective view showing an outline of the linear motor 1 of a first embodiment. The specific configuration of the linear motor 1 shown in FIG. 1 is shared with the second to seventh embodiments described later. FIG. 2 is a cross-sectional view of the linear motor 1. FIG. 2 shows the cross section in a plane parallel to the X-Z plane of the linear motor 1. It should be noted that FIG. 2 shows a bolt by external appearance rather than a cross section. FIG. 3A is a plan view showing an arrangement of plates 11. FIG. 3A shows a state arranging five of the plates 11 along the X direction. FIG. 3B is a plan view showing an arrangement of guiderails 14. FIG. 3B shows a state arranging the guiderail 14 on the machine mounting part 30.

As shown in FIG. 1, the linear motor 1 includes a plurality of magnet plates (magnet plate for linear motor) 10, and an armature 20. The magnet plates 10 are field magnetic poles in which permanent magnets 12 (described later) of different polarity are alternately arranged along the driving direction (X direction of the armature 20. The magnet plate 10 generates drive force for causing the armature 20 to linearly move, i.e. drive force for linear movement, in cooperation. with the armature 20. The magnet plate 10 includes the plate 11, groove 110, permanent magnets 12, joining layer 13 and guiderail 14, as shown in FIG. 2.

The plate 11 is a plate-shaped metallic member. The plate 11 has a first face F1 serving as a face on a Z1 side, and a second face F2 serving as a face on a Z2 side, as shown in FIG. 2. The first face F1 is a face on which a plurality of permanent magnets 12 is arranged. The second face F2 is a face fixed to the machine mounting part 30 (described later).

In the linear motor 1 of the present embodiment, five of the plates 11 (magnet plates 10) are arranged along the longitudinal direction (X direction) as shown in FIG. 1. On the first face F1 of each plate 11, eight of the permanent magnets 12 are arranged, respectively. It should be noted that the plate 11 may be arranged in a state slightly skewed (slanted) relative to the longitudinal direction (X direction) of the magnet plate 10. In addition, the number, shape, etc. of plates 11 are not limited to the example of the present embodiment, and are set as appropriate according to the specifications, etc. of the linear motor 1.

The plate 11 includes the groove (first fitting part) 110 on the side of the second face F2. The groove 110 of the present embodiment is configured as a trapezoidal dovetail groove in which a width W1 on the first face F1 side is wider than a width W2 on the second face F2 side in a cross section parallel to a Y-Z plane.

The groove 110 is provided at a central part in the Y direction of the plate 11, and extends along the X direction, as shown in FIG. 3A. In other words, the groove 110, when arranging the plates 11 as in FIG. 3A, is formed so as to extend along the movement direction (X direction) of the armature 20. As shown in FIG. 3A, when arranging five of the plates 11, the grooves 110 provided in each of the plates 11 communicate in the X direction. The guiderail 14 described later fits in the communicating grooves 110 of the arranged plates 11.

The plate 11 includes a stepped hole 111 in an end in the Y1 direction and an end in the Y2 direction, as shown in FIG. 3A. The stepped hole 111 is a hole into which a bolt 112 (described later) is inserted upon fixing the plate 11 to the machine mounting part 30. The plate 11, for example, is formed by a laminated body of silicon steel plate, carbon steel, general structural rolled steel, or the like.

The permanent magnet 12 is a member that generates a magnetic field, and is arranged via the joining layer 13 on the first face F1 of the plate 11, as shown in FIG. 2. For the permanent magnets 12, an N-pole permanent magnet 12 and S-pole permanent magnet 12 are alternately arranged along the drive direction (X direction) of the armature 20, on the first face F1 of the plate 11. The joining layer 13 is a layer joining the plate 11 and permanent magnet 12, and is formed by adhesive, for example.

In the present embodiment, eight of the permanent magnets 12 are arranged in a pattern of 4 (Y direction)×2 (X direction), on one plate 11, as shown in FIG. 1. It should be noted that the number, arrangement form, etc. of the permanent magnets 12 arranged on the plate 11 are not limited to the examples of the present embodiment, and are set as appropriate according to the specifications, etc. of the linear motor 1.

The guiderail (second fitting part) 14 is a member which suppresses deformation of the plate 11, by fitting with the groove 110 provided to the plate 11. As deformation of the plate 11, for example, the plate 11 including the permanent magnets 12 warping to the side of the armature 20 (Z1 side), by the attractive force of the magnetic field generated between the magnet plate 10 and armature 20 during driving of the linear motor 1, can be exemplified.

The guiderail 14 is formed in a rod shape which is overall long and narrow, as shown in FIG. 3B. The guiderail 14 is arranged so that the longitudinal direction follows the X direction of the machine mounting part 30. In other words, the guiderail 14 extends along the movement direction (X direction) of the armature 20 in the machine mounting part 30. The guiderail 14 is configured in dovetail key that is a substantially similar shape to the groove 110 (dovetail groove) in a cross section parallel to the Y-Z plane as shown in FIG. 2.

In the present embodiment, since the cross-sectional shape of the groove 110 is made a dovetail groove, and the cross-sectional shape of the guiderail 114 is made into a dovetail key that is substantially similar shape to the dovetail groove of the groove 110, it is possible to suppress the plate 11 from warping to the side of the armature 20 (Z1 side), by fitting the groove 110 to the guiderail 14. In addition, according to the configuration of the present embodiment, it is possible to more reliably have the plate 11 fit to the machine mounting part 30, and possible to allow the plate 11 to more smoothly relatively move in the X direction on the guiderail 14.

The stepped holes 141 are provided at five points in the longitudinal direction (X direction) in the guiderail 14 as shown in FIG. 3B. The stepped hole 141 is a hole into which a bolt 142 (not illustrated) is inserted upon fixing the guiderail 14 to the machine mounting part 30. As shown in FIG. 2, a bolt hole 301 (described later) is provided in the machine mounting part 30 at a position corresponding to the stepped hole 141 of the guiderail 14. As described later, after arranging the guiderail 14 on the machine mounting part 30, by inserting the bolt 142 into the stepped hole 141 of the guiderail 14, and threading to fasten in the bolt hole 301, it is possible to fix the guiderail 14 to the machine mounting part 30. The guiderail 14 is formed by carbon steel, general structural rolled steel, or the like, for example.

The machine mounting part 30, for example, is a location at which the linear motor 1 installed, as a drive device such as of the magnetic head drive mechanism of an OA machine, and spindle/table feed mechanism of a machine tool. In the present embodiment, although the machine mounting part 30 is illustrated as a plate-shaped member, in reality, it has a shape depending on the machine to be installed. As shown in FIG. 2, the machine mounting part 30 includes the bolt hole 301 at a position corresponding to the stepped hole 141 of the guiderail 14. The bolt hole 301 has, at an inner circumferential face, a female thread which can thread together with the male thread of the bolt 142 inserted into the stepped hole 141 of the guiderail 14

In addition, the bolt hole 302 is provided in the machine mounting part 30 at a position corresponding to the stepped hole 111 of each plate 11, as shown in FIG. 3B. The bolt hole 302 has, at an inner circumferential surface, a female thread which can screwed together with the male thread of the bolt 112 inserted into the stepped hole 111 of the plate 11 (magnet plate 10).

The armature 20 generates driving force for causing the armature 20 to move linearly in cooperation with the magnet plate 10. The armature 20 includes an iron core, winding, etc. (not illustrated). The iron core is a member serving as a main body of the armature 20, for example, and is configured as a structure made by stacking a plurality of plates consisting of magnetic material. The winding is wire which is coiled in slots in the iron core. Alternating current electric power is supplied from an external power supply. FIG. 1 omits illustration of cables supplying electric power to the winding of the armature 20, for example.

When applying single-phase alternating current or three-phase alternating current as electric power to the winding of the armature 20, attractive force and repellent force act between the shifting magnetic field produced by the winding and the magnetic field of the magnet plate 10, and thrust is imparted on the armature 20 by a component thereof in the driving direction (X direction). The armature 20 linearly moves along the X direction in which the permanent magnets 12 of the magnet plate 10 are arranged, as shown in FIG. 1, by way of this thrust.

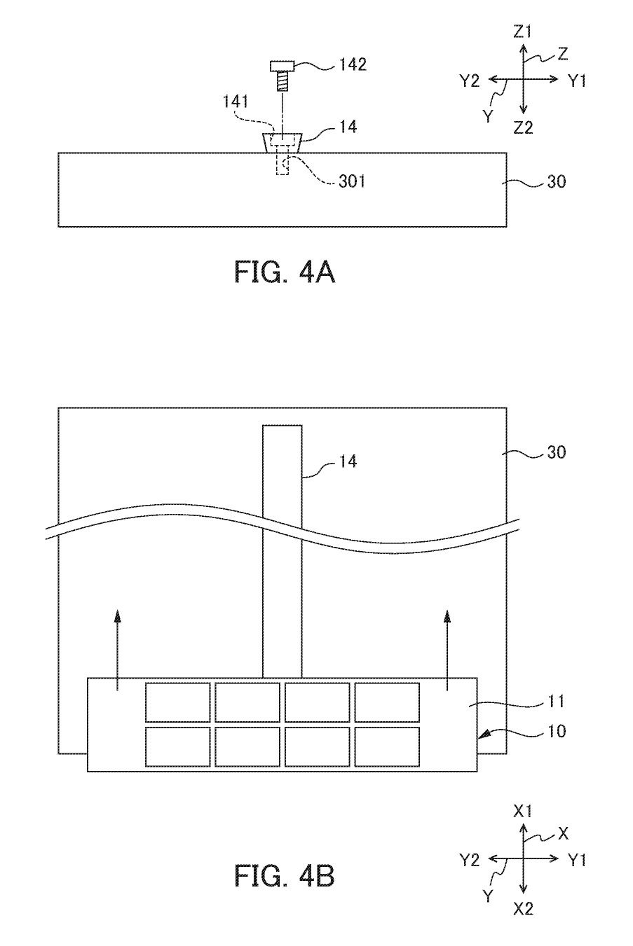

Next, the assembly procedure of the magnet plate 10 will be explained while referencing the respective drawings. FIG. 4A and FIG. 4B are views showing the assembly procedure of the magnet plate 10. FIG. 4A is a side view when viewing the machine mounting part 30 from the X2 side to X1 side. FIG. 4B is a plan view when viewing the machine mounting part 30 and magnet plate 10 from the Z1 side to Z2 side. It should be noted that illustrations of the stepped hole, bolt, etc. are omitted as appropriate in FIG. 4A and FIG. 4B.

First, as shown in FIG. 4A, the guiderail 14 is arranged on the machine mounting part 30. In more detail, the guiderail 14 is arranged so that the stepped hole 141 of the guiderail 14 and the bolt hole 301 provided in the machine mounting part 30 match. Then, the bolt 142 is inserted into the stepped hole 141 of the guiderail 14, and screwed into the bolt hole 301 to fasten. The guiderail 14 is thereby fixed to the machine mounting part 30.

Next, the groove 110 of the magnet plate 10 and the guiderail 14 are fit together, and in this state (refer to FIG. 2), the magnet plate 10 is made to move up to a predetermined position in the X1 direction as shown in FIG. 4B. In other words, each of the magnet plates 10 is made to move up to a position at which the stepped hole 111 formed in the plate 11 of the magnet plate 10 (refer to FIG. 3A) and the bolt hole 302 provided in the machine mounting part 30 (refer to FIG. 3B) match.

In the present embodiment, each of the five magnet plates 10 is made to move up to a predetermined position in a state fitted together with the guiderail 14, the bolt 112 is inserted into the stepped hole 111 of the magnet plate 10, and screwed into the bolt hole 302 to fasten. The five magnet plates 10 are thereby fixed to the machine mounting part 30 via the guiderail 14, as shown in FIG. 1.

According to the aforementioned linear motor 1 of the present embodiment, it is possible to fix the magnet plates 10 to the machine mounting part 30 in a state suppressing deformation of the plate 11, by fitting together the groove 110 of the plate 11 and the guiderail 14. For this reason, during driving of the linear motor 1, it is possible to suppress the plate 11 from warping to the side of the armature 20, due to the attractive force of the magnetic field produced between the magnet plates 10 and armature 20. Therefore, according to the linear motor 1 of the present embodiment, during driving, it is possible to keep the spacing between the armature 20 and magnet plates 10 at the appropriate interval.

It should be noted that, by increasing the thickness of the plate 11 of the magnet plate 10, it is possible to raise the flexural rigidity in the width direction (Y direction) of the magnet plate 10. However, when increasing the thickness of the plate 11, not only will the cost increase, but also problems arise such as the performance of the linear motor declining by the mass of the magnet plate 10 increasing, and the workability during production worsening.

In addition, it can be considered to increase the number of bolts fixing the plate 11 to the machine mounting part 30, along the longitudinal direction of the plate 11. However, since it is no longer possible to arrange permanent magnets 12 at places where providing bolts, the thrust per unit area will decline if increasing the number of bolts. In contrast, since there is no necessity to increase the number of bolts fixing the plate 11 to the machine mounting part 30 in the linear motor 1 of the present embodiment, it is possible to suppress a decline in thrust per unit area.

In addition, in the case of configuring the magnet plate 10 as a drive side as described later, the mass of the magnet plate 10 will increase by increasing the thickness of the plate 11, and increasing the number of bolts, whereby it can be considered that the performance of the linear motor (maximum acceleration, etc.) will decline. However, with the linear motor 1 of the present embodiment, even in the case of configuring the magnet plate 10 as a drive side, since it is possible to suppress an increase in mass of the magnet plate 10, the performance of the linear motor can be further improved.

In the linear motor 1 of the present embodiment, the groove 110 of the magnet plate 10 (plate 11) and the guiderail 14 extend along the movement direction (X direction) of the armature 20. For this reason, by moving the magnet plate 10 up to a predetermined position in the X direction in a state fitting together the groove 110 of the magnet plate 10 and the guiderail 14, it is possible to more accurately and simply arrange the magnet plates 10 at the desired positions.

In the linear motor 1 of the present embodiment, the groove 110 is configured as a dovetail groove. In addition, the guiderail 14 is configured in a dovetail key that is substantially similar shape as the groove 110 (dovetail groove). For this reason, by fitting together the groove 110 with the guiderail 14, it is possible to have the plate 11 and machine mounting part 30 more reliably fit tightly. In addition, it is possible to have the plate 11 more smoothly relatively move in the X direction on the guiderail 14.

### Second to Fourth Embodiments

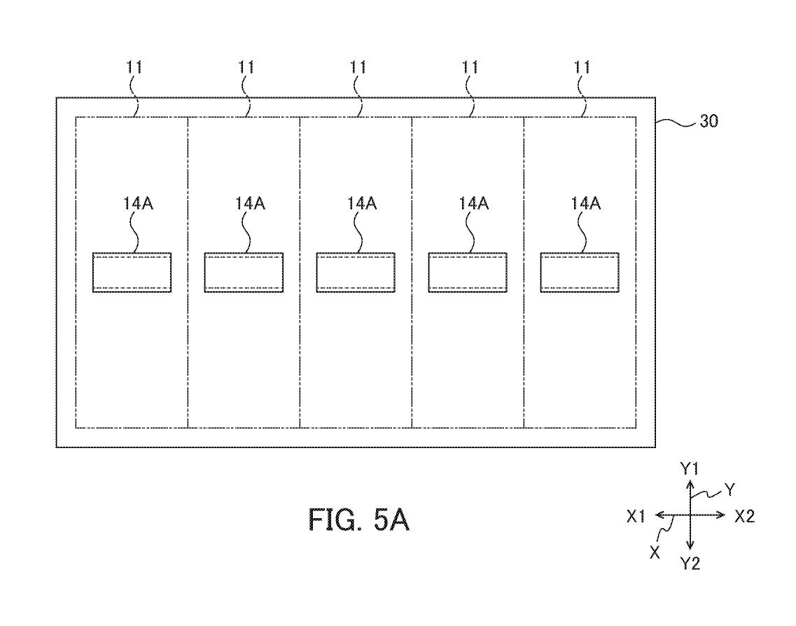

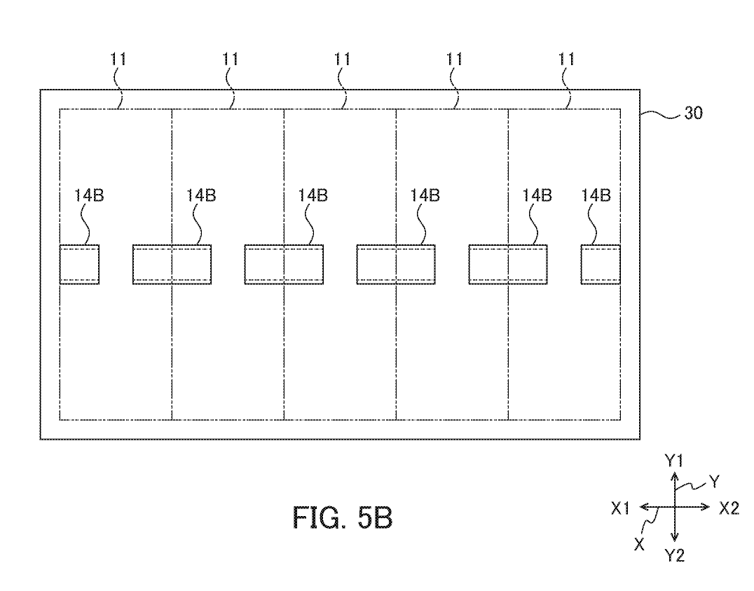

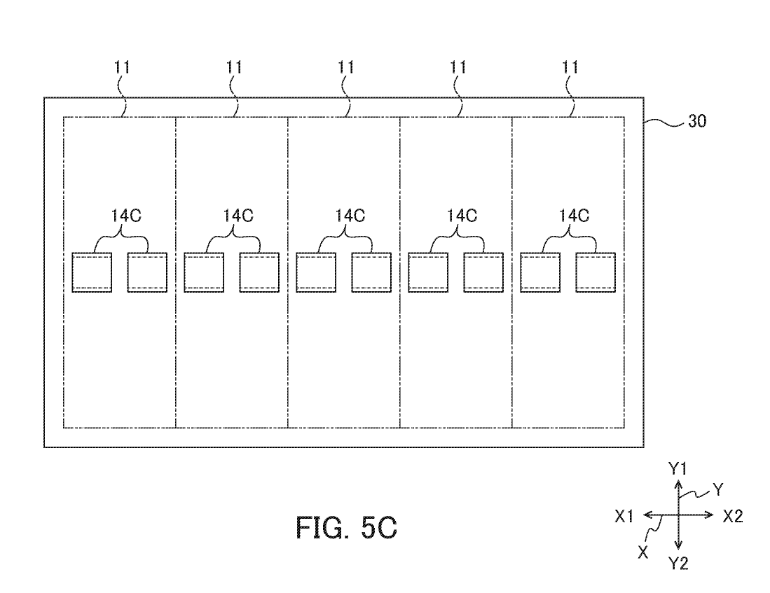

FIGS. 5A to 5C are views respectively showing second to fourth embodiments of the guiderail 14. FIG. 5A is a plan view showing the configuration of a guiderail 14A of the second embodiment. FIG. 5B is a plan view showing the configuration of a guiderail 14B of the third embodiment. FIG. 5C is a plan view showing the configuration of a guiderail 14C of the fourth embodiment. FIGS. 5A to 5C correspond to FIG. 3B (first embodiment). In FIGS. 5A to 5C, the contour of the plate 11 (magnet plate 10) fitting together with the guiderails 14A to 14C is shown by an imaginary line (two-dot chain line). In addition, illustrations of the stepped hole, bolt, etc. are omitted as appropriate in FIGS. 5A to 5C. In the explanation and drawings for the second to fourth embodiments, the same reference symbols as the first embodiment are attached to members, etc. equivalent to the first embodiment, and otherwise redundant explanations are omitted.

The guiderail 14A of the second embodiment shown in FIG. 5A is formed shorter than the guiderail 14 of the first embodiment, and is arranged only at a position corresponding to the plate 11 in the X direction of the machine mounting part 30. Each guiderail 14A shown in the second embodiment is arranged intermittently along the X direction; however, they extend in the X direction as a whole.

The guiderail 14B of the third embodiment shown in FIG. 5B is formed shorter than the guiderail 14 of the first embodiment, and is arranged so as to straddle between adjacent plates 11 in the X direction of the machine mounting part 30. The guiderail 14B of the third embodiment is formed in a length fitting together with each of two adjacent plates 11. It should be noted that the guiderails 14B arranged at the ends on the X1 side and X2 side are each formed in a length fitting together with one plate 11. Each of the guiderails 14B shown in the third embodiment is arranged intermittently along the X direction; however, it extends in the X direction as whole.

The guiderail 14C of the fourth embodiment shown in FIG. 5C is formed even shorter than the guiderail 14 of the first embodiment, and is arranged at two locations corresponding to the plate 11 in the X direction of the machine mounting part 30. The guiderail 14C of the fourth embodiment is arranged intermittently along the X direction; however, it extends in the X direction as a whole. It should be noted that the shape in the X-Y plane of the guiderail 14C of the fourth embodiment is not limited to quadrilateral such as that shown in FIG. 5C, and may be circular, for example.

### Fifth Embodiment

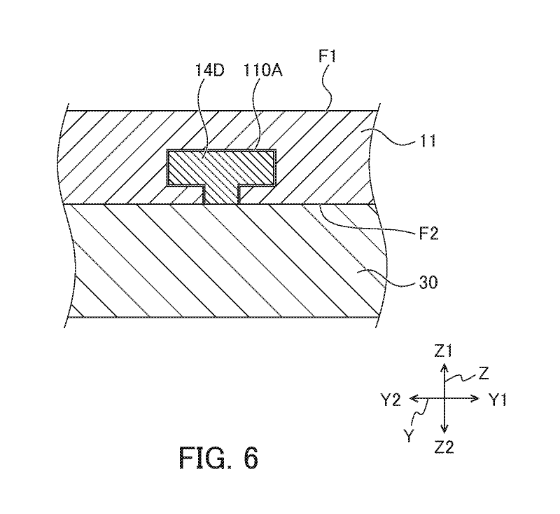

FIG. 6 is a cross-sectional view showing the configurations of a groove 10A and guiderail 14B of the fifth embodiment. It should be noted that illustrations of the stepped hole, bolt, etc. are omitted in FIG. 6. In the explanation and drawings of the fifth embodiment, the same reference symbols as the first embodiment are attached to members, etc. equivalent to the first embodiment, and otherwise redundant explanations are omitted.

As shown in FIG. 6, the groove 110A of the fifth embodiment is formed in an inverse convex shape in a cross section parallel to the Y-Z plane. In addition, the guiderail 14D is configured in an inverse convex shape that is a substantially similar shape to the groove 110A in a cross section parallel to the Y-Z plane. In this way, so long as the groove 110 at least partially has a cross-sectional shape indented so as to expand from the second face F2 to the first face F1 of the plate 11, it is not limited to the combination of a dovetail groove and a dovetail key such as those shown in FIG. 2. For example, the quadrilateral portion of the groove 110A shown in FIG. 6 may be made a cross-sectional shape such as semicircular, circular or triangular.

### Sixth and Seventh Embodiments

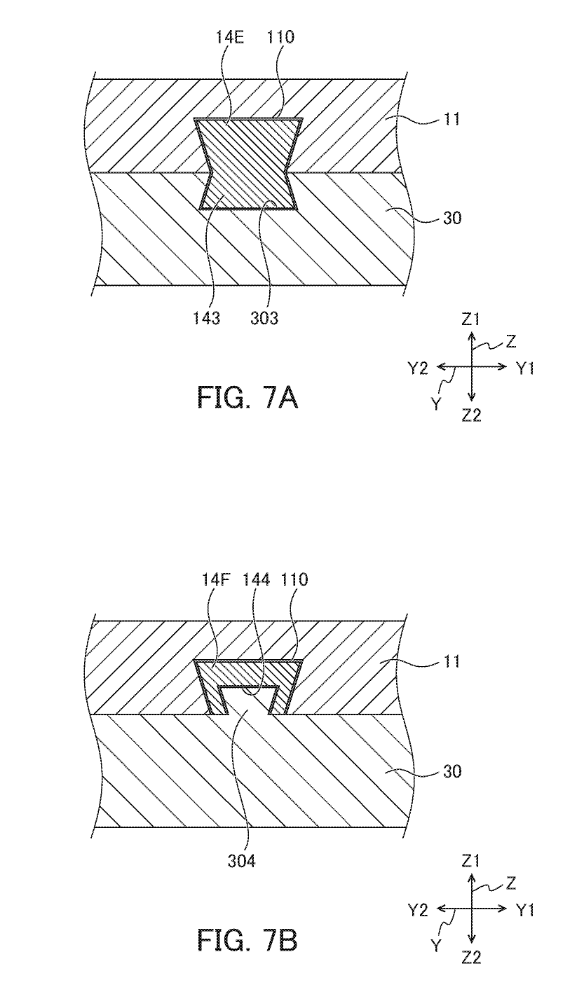

FIGS. 7A and 7B are cross-sectional views respectively showing the configurations of the groove 110 and guiderail 14 of the sixth and seventh embodiments. FIG. 7A is a cross-sectional view showing the configurations of the groove 110 and guiderail 14E of the sixth embodiment. FIG. 7B is a cross-sectional view showing the configurations of the groove 110 and guiderail 14F of the seventh embodiment. In the explanations and drawings of the sixth and seventh embodiments, the same reference symbols as the first embodiment are attached to members, etc. equivalent to the first embodiment, and otherwise redundant explanations are omitted.

As shown in FIG. 7A, the machine mounting part 30 of the sixth embodiment includes a mounting groove 303. The mounting groove 303 is configured as a dovetail groove, and extends in a direction (X direction) orthogonal to the Y-Z plane in FIG. 7A. On the other hand, the guiderail 14E includes a fitting part 143 at a surface on the side of the machine mounting part 30. The fitting part 143 is configured as a dovetail key which is substantially similar shape to the mounting groove 303 (machine mounting part 30), in a cross section parallel to the Y-Z plane. Other shapes of the guiderail 14E are the same as the first embodiment. According to the present embodiment, by fitting the fitting part 143 of the guiderail 14E with the mounting groove 303 of the machine mounting part 30, it is possible to fix the guiderail 14E to the machine mounting part 30, without using bolts or the like.

In addition, a plurality of circular mounting holes may be formed linearly in the machine mounting part 30 in place of the mounting groove 303, and the shape of the fitting part 143 of the guiderail 14E may be provided as a plurality of circular rod shapes which can fit with the mounting holes. In this case, by fitting the circular rod-shaped fixing parts of the guiderail 14E into the mounting holes by press-fitting or cold-fitting, it is possible to fix the guiderail 14E to the machine mounting part 30 without using bolts or the like.

As shown in FIG. 7B, the guiderail 14F of the seventh embodiment includes a mounting groove 144 in a surface on the side of the machine mounting part 30. The mounting groove 144 is configured as a dovetail groove, and extends in a direction (X direction) which is orthogonal to the Y-Z plane in FIG. 7B. Other shapes of the guiderail 14F are the same as the first embodiment. On the other hand, the machine mounting part 30 includes a fixing part 304. The fixing part 304 is configured as a dovetail key which is a substantially similar shape to the mounting groove 144 (guiderail 14) in a cross section parallel to the Y-Z plane. According to the configuration of the present embodiment, by fitting the mounting groove 144 of the guiderail 14F together with the fixing part 304 of the machine mounting part 30, it is possible to fix the guiderail 14 to the machine mounting part 30, without using bolts or the like.

Although embodiments of the present invention have been explained above, the present invention is not to be limited to the aforementioned embodiments, and various modifications and changes are possible as in the modified examples described later, and these are also included within the technical scope of the present invention. In addition, the effects described in the examples are merely listing the most preferred effects produced from the present invention, and are not to be limited to those described in the embodiments. It should be noted that the aforementioned embodiments and modified examples described later can be used in combination as appropriate; however, detailed explanations will be omitted.

### Modified Examples

The embodiments explain examples in which the groove 110 is formed integrally with the plate 11; however, it is not limited thereto. The groove 110 may be configured as a rail-shaped member, and this member may be made a configuration fixed by bolts, etc. to the plate 11. The embodiments explain a configuration including the groove 110 and guiderail 14 as one group in the linear motor 1; however, it is not to be limited thereto. It may be made a configuration arranging a plurality of groups of the grooves 110 and the guiderails 14 in the Y direction.

The embodiments explain examples defining the guiderail 14 as a separate component from the machine mounting part 30, and fixing by the bolts 142; however, it is not to be limited thereto. A guide part may be formed integrally with the machine mounting part 30. The embodiments explain examples of fitting the plates 11 together from the X direction; however, it is not to be limited thereto. The guiderail 14 may be made to extend in the Y direction, and be configured so as to fit the plates 11 together from the Y direction.

The groove 110 and guiderail 14 may be formed in tapered shapes along the longitudinal direction. By establishing such a configuration, it is possible to suppress rattle, positional displacement, etc. of the plate 11 relative to the guiderail 14. In addition, the groove 110 and guiderail 14 may be fit together using a technique such as cold-fitting. By together with such a technique, it is possible to more effectively suppress rattle, positional displacement, etc. of the plate 11 relative to the guiderail 14 due to being able to fit together more firmly the groove 110 and guiderail 14. The embodiments explain examples establishing the magnet plate 10 as the fixed side, and establishing the armature 20 as the drive side; however, it is not limited thereto. In the linear motor 1, it may establish the magnet plate 10 as the drive side, and establish the armature 20 as the fixed side.

### EXPLANATION OF REFERENCE NUMERALS

1: linear motor; 10: magnet plate; 11: plate; 12: permanent magnet; 14: guiderail; 20: armature; 30: machine mounting part; 110: groove

What is claimed is:

1. A magnet plate for a linear motor that generates driving force for linear motion in cooperation with an armature, the magnet plate comprising:
a plate having a first face and a second face on an opposite side to the first face, and provided with a first fitting part at least partially having a cross-sectional shape indented so as to expand from the second face towards the first face;
a permanent magnet disposed on the first face of the plate; and
a second fitting part that is fixed to a machine mounting part, and has a cross-sectional shape which can fit together with the first fitting part of the plate.

2. The magnet plate for a linear motor according to claim 1, wherein the first fitting part and the second fitting part extend along a movement direction of the armature.

3. The magnet plate for a linear motor according to claim 2,
wherein the first fitting part is a dovetail groove having a width wider on a side of the first face than a width on a side of the second face in a cross section orthogonal to an extending direction, and
wherein the second fitting part is a guiderail of a dovetail key which is a substantially similar shape to the dovetail groove in a cross section orthogonal to an extending direction.

4. A linear motor comprising:
an armature; and
the magnet plate for a linear motor according to claim 1.
